(19) United States
(12) Patent Application Publication
(10) Pub. No.: US 2007/0287395 A1
(43) Pub. Date: Dec. 13, 2007

(54) Method and signal intelligence collection system that reduces output data overflow in real-time

(76) Inventor: Lars Karlsson, Santa Clara, CA (US)

Correspondence Address: KENYON & KENYON LLP, 1500 K STREET N.W., SUITE 700, WASHINGTON, DC, 20005, US

(21) Appl. No.: 11/201,164

(22) Filed: Aug. 11, 2005

Related U.S. Application Data
(60) Provisional application No. 60/600,657, filed on Aug. 11, 2004.
(60) Provisional application No. 60/600,642, filed on Aug. 11, 2004.
(60) Provisional application No. 60/600,641, filed on Aug. 11, 2004.
(60) Provisional application No. 60/600,643, filed on Aug. 11, 2004.

(51) Int. Cl. H04B 17/02; H04B 7/08; H04B 1/06

(52) U.S. Cl. 455/133; 455/140; 455/277.1

(57) ABSTRACT

Systems and methods of collecting intelligence provide an intelligence system having a front-end, a post-processing stage and a direction-finding stage. The front-end may generate digital data based on received RF signals, where the post-processing stage may process the digital data. The direction finding stage is able to prevent the post-processing stage from processing portions of the digital data that correspond to RF signals arriving from a direction other than a pre-determined direction. In one embodiment, the front end collects the RF signals in a plurality of parallel channels.

The present application claims priority to U.S. Provisional Patent Application No. 60/600,657, filed on Aug. 11, 2004, incorporated herein by reference, U.S. Provisional Patent Application No. 60/600,642, filed on Aug. 11, 2004, U.S. Provisional Patent Application No. 60/600,641, filed on Aug. 11, 2004, and U.S. Provisional Patent Application No. 60/600,643, filed on Aug. 11, 2004.

### CROSS-REFERENCE TO RELATED APPLICATION

The present application is related to the U.S. patent application entitled “Method and Technique for Gathering Signal Intelligence of All Radio Communications Only Originating from Specific Selected Areas,” and filed on even date herewith.

### BACKGROUND

1. Technical Field

Certain embodiments of the present application generally relate to intelligence collection systems. In particular, some embodiments relate to intelligence systems that use direction information as a discriminator.

2. Discussion

Present day military-grade signal collection and surveillance equipment is used to capture communications transmissions from enemy radios and/or clandestine sources. The interception of various wireless communications is a critical signal intelligence function that is vital for national security interests. The captured signals and raw data energy are then fed to a post-processing stage, where the actual voice or digital data is extracted. Currently, the high end signal collection equipment that is used outputs too much information that overwhelms the post-processing capabilities of military units and intelligence organizations (such as the National Security Agency—NSA). This is a significant problem today. The current signal collection equipment floods the signal post-processing pipeline with extraneous and false positive indications of the presence of interesting signals, also known as “false hits.” The sheer amount of signal data that is collected exceeds the abilities of both manpower and computer power to analyze them in a timely manner. The modern military unit or intelligence organization needs tools to filter (quickly and automatically) the extraneous and/or false data before it gets into the post-processing pipeline. This present requirement is critical since currently there are not enough assets to properly monitor all captured signal data.

For example, the NSA currently has a well-documented problem: how to allocate human and computer resources to analyze all the radio communications the agency collects, especially when the vast majority of the communications collected do not impinge upon the national security. The NSA spends hundreds of millions of dollars sifting through endless mountains of data, most of which is eventually discarded. Tools that make the sifting process much more efficient thus not only save money, but also enhance the security of the nation.

The National Security Agency's Blackbird signal collection systems employ wideband receivers on its front end. The capabilities of the wideband receivers allow the Blackbird to collect many signals from many sources, many more signals than can be analyzed at once. The wideband receivers are extremely capable at collecting signals, and thus almost become part of the data analysis problem. They are so capable that they currently flood the analysis pipeline with extraneous signal “hits”.

This flood of information will only increase in the future as the collection capabilities of the wideband front end increase exponentially. The analysis capabilities of the processing pipeline must also increase exponentially to avoid exacerbating the glut.

Such an information glut can pose a significant threat to national security because the intelligence information ages quickly. As a result, much of the signal data as possible needs to be analyzed in a timely manner. The current glut forestalls this timely analysis.

### BRIEF DESCRIPTION OF THE DRAWINGS

The various advantages of embodiments of the present invention will become apparent to one skilled in the art by reading the following specification and appended claims, and by referencing the following drawings, in which:

FIG. 1 is a block diagram of an example of a conventional signal processing and analysis system;

FIG. 2 is a block diagram of an example of a signal processing and analysis system with direction-finding (DF) capabilities according to an embodiment; and

FIG. 3 is a block diagram of an example of an intelligence system according to an embodiment.

### DETAILED DESCRIPTION

In the following detailed description, numerous specific details are set forth in order to provide a thorough understanding of the various embodiments of the present invention. It will be apparent to one of ordinary skill in the art that these specific details need not be used to practice various embodiments of the present invention. In other instances, well-known structures, interfaces, and processes have not been shown in detail in order not to unnecessarily obscure various embodiments of the present invention.

Certain embodiments of the present invention add direction information as a discriminator to the front end of signal detection systems, thus automatically filtering extraneous signals arriving from directions -NOT- of interest to the intelligence organization. The embodiments of the invention are therefore vital to the interests of United States national security in that they allow less information to be collected that is “better” in nature. Thus, the extraction of intelligence is far more efficient than conventional methods.

What is needed therefore in order to feasibly analyze the mountain of signals detected by modem signal collection systems is a real-time processing filter that discards as many extraneous signals as possible. Such a system may include: 1) the ability to gather short duration communication signals as described in references such as U.S. patent application Ser. No. 10/829,858, filed on Apr. 21, 2004, incorporated herein by reference (hereinafter “the '858 application”), and 2) the ability to identify the specific compass direction from the collection unit, or sector of the source of the signal, also in near real time. The user of the embodiments of this invention can direct the system to filter out unwanted signals simply by specifying the compass direction of arrival of the signal sources to be analyzed.

Embodiments described herein enable such functionality. Simply put, no known solutions autonomously filter short duration signals, transmitted from a specified direction or sector, in near real-time.

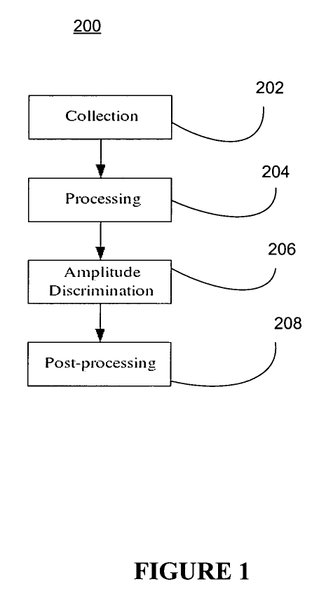

FIG. 1 shows a block diagram of an example of a conventional signal collection and analysis system 200. The illustrated system 200 separates the signal pipeline into four stages: collection, processing, amplitude discrimination, and post-processing. The collection stage 202 contains the radio frequency receiving hardware: antennas, wideband receivers, etc. The processing stage 204 contains one or more hardware logic modules which perform fast fourier transformations (FFTs). The amplitude stage 206 contains hardware that performs peak detection algorithms to determine the amplitudes of the frequencies received. The post-processing stage 208 contains more computer resources, as well as human resources, to completely analyze the intelligence worthiness of each signal that makes it through this chain.

What is to be noticed is that any signals that pass the amplitude discrimination stage/test 206 are passed directly into the post-processing stage 208. These signals receive post-processing which occupies both computer and human resources. The presence and amplitude of a signal (so called “energy detection”) are the only discriminators used to choose which signals are post-processed. Thus, there may be an overload of data.

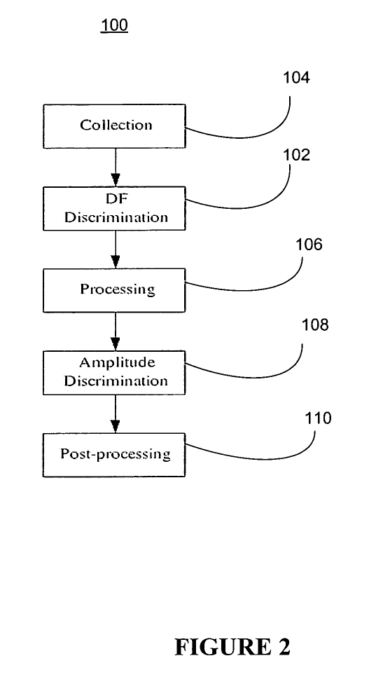

FIG. 2 shows a block diagram of a signal collection and analysis system 100 that has direction-finding capabilities according to an embodiment of the present invention. The system 100 separates the signal pipeline into five stages: a collection stage 104, direction-finding (DF) discrimination stage 102, processing stage 106, amplitude discrimination stage 108, and post-processing stage 110. In general, signals that do not pass the direction-finding stage/test 102 are discarded and not processed any further by the pipeline. It is worthy to note that the DF stage 102 is powerful and configurable discriminator—the use and real-time implementation of which in signal collection systems is unique. In the illustrated example, the remaining stages are similar to the stages of the conventional system 200 (FIG. 1) with the addition of features to support the functionality of the direction-finding stage 102. In one embodiment, the direction-finding stage 102 can use a standard DF algorithm (for example the well documented Watson-Watt algorithm) to determine the direction of a signal.

A few items can be noticed from the system 100:
1. The direction-finding stage/algorithm 102 adds a new discriminator besides presence and amplitude of a signal, so that many more signals will be discarded rather than enter the post-processing stage 1 10 of the pipeline.
2. The direction-finding stage/algorithm 102 determines whether to discard a signal or not before any significant processing takes place. This discrimination of direction at such an early stage is unique.
3. Because the signals outside the sectors of interest are discarded so quickly, the overall efficiency of the entire pipeline is maximized. As a result, both human and computer resources are used much more efficiently.

The capabilities of the system 100 therefore solve the aforementioned overload challenges by discriminating signals on the basis of direction of arrival.

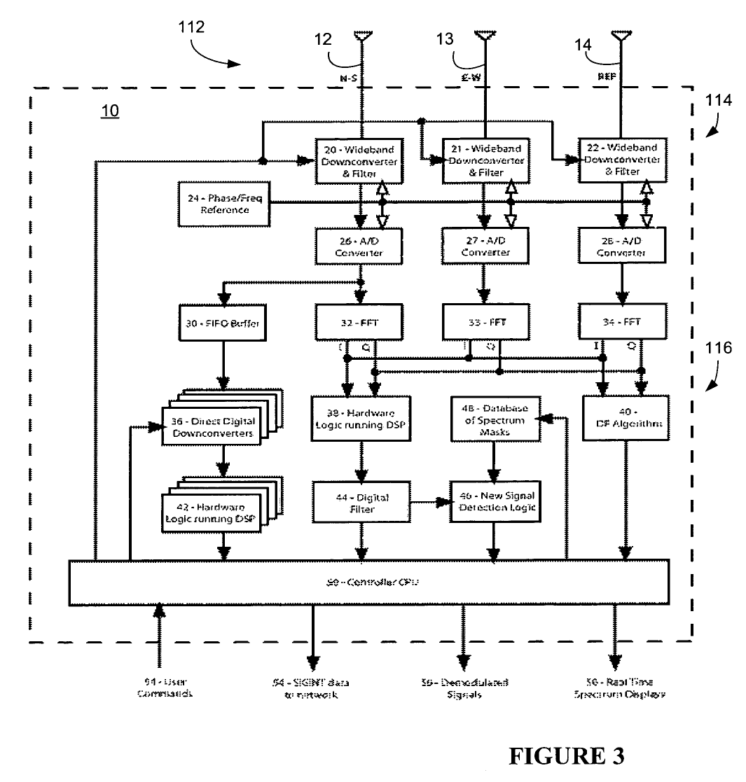

FIG. 3 outlines a more detailed block diagram of an intelligence system 10 according to one embodiment of the present invention. The illustrated system 10 is generally made up of three sections. The first section 112 includes an array of three antennas 12, 13, 14 that can be used to provide signals with time and phase differences that are eventually fed to a DF algorithm 40. The next section 114 in the illustrated example includes three data channels—one to handle the input from each antenna. These channels can be identical in hardware and software implementation. One approach to each channel is described in more detail in the '858 application, already discussed. In addition to the front end channels, the illustrated system 10 has hardware logic to automatically make a determination as to whether the signal is from the compass direction of interest or not. This logic section can contain a time and/or phase DF algorithm 40 to calculate the direction of the received signals. The rest of the parts of the system 10 may be constructed as described in conventional systems such as the systems described in the '858 application. All processing can therefore be done in near real-time, with no human intervention.

In one embodiment, the system 10 is implemented in hardware, in real-time, without any human intervention. The system 10 can replicate the front half of the system described '858 application into three separate data channels, while adding direction-finding capabilities. Each data channel can start with one receiving antenna out of an array of three antennas, where the array provides direction-finding capability.

The next section 116 of the system 10 recombines the front halfs three data channels into one data channel. This section contains the selection logic that automatically determines whether or not the received signal should be discarded, based on the compass direction of the source of the signal. The part of the logic section most relevant to this patent application is the DF algorithm 40 to that calculates the direction of the received signals.

A couple items to notice:
1. The illustrated direction-finding algorithm 40 is native to the front-end of the process; it is part of the signal flow just after signal collection. This is not true of conventional systems.
2. The direction-finding algorithm can be implemented in dedicated hardware, rather than on a CPU. This dedicated hardware provides speed that software running on a CPU cannot. Thus, short duration signals can be “DF'd.”
3. Every single frequency point in the capture bandwidth of the front end receivers can be DF'd simultaneously. This is not possible with conventional methods and is unique in that every single frequency measurement has a direction calculated for it.

The illustrated system 10 is unique since no other device has the capability or performance to perform these operations, and in real-time.

### INVENTION DIAGRAM REFERENCE NUMERALS

10 Intelligence system
12, 13, 14 Receiving Antennas
20, 21, 22 Wideband Downconverters and Filters
24 Phase/Frequency Reference
26, 27, 28 Analog-to-Digital Converters (A/D)
30 FIFO Buffer
32, 33, 34 Fast Fourier Transformations (FFT's)
36 Direct Digital Downconvertors
38 Hardware Logic DSP
40 DF Algorithm
42 Hardware Logic DSP
44 Digital Filter
46 New Signal Detection Logic
48 Database of Spectrum Masks
50 Controlling CPU
52 User Commands
54 SIGINT Output
56 Demodulated Signals
58 Real-time Spectrum Displays
   Operation

Adding direction finding capabilities to conventional systems may involve three changes: the addition of user commands that specify the signal source directions of interest, the replication of the receiving hardware, and the addition of dedicated hardware that implements a direction-finding algorithm.

The additional user command can involve specifying compass directions of interest. For ease of use, the system operator may be given a circular compass display to indicate the (possibly multiple) directions required. The operator can use the compass display to sweep out the sector, or sectors, of interest. All other user commands may remain the same as in systems such as the systems described in the '858 application.

To add direction-finding capabilities, an array of three or more receiving antennas can be used which feed into three receiver channels. Typically, in the Watson-Watt direction finding method, the DF antennas that are commonly used are so-called Adcock DF Antennas. These antennas have three outputs, the N-S (North-South), E-W (East-West), and REF (Reference) antenna outputs which are then fed into the invention.

Converter devices 20, 21, and 22 are connected, one to each antenna input as described above, to down-convert the received signals. As described above, much of the hardware of the '858 application can be replicated to process input from three or more antennas in parallel (instead of only one antenna).

The operation of the data channels from the down-converters 20, 21, and 22 through the FFT devices 32, 33, and 34 can be identical to that of individual channels described in the '858 application, where the individual channel is replicated into three data channels instead of one.

All the information from the three bin arrays from the three FFT hardware devices can then be fed to the illustrated hardware logic component that includes a direction finding (DF) algorithm 40. Because the three receiving antennas are in slightly separate locations, the data in each of the three bin arrays is slightly time and/or phase shifted from each other. The DF algorithm 40 can use the slight differences between the three corresponding bins from each of the three bin arrays to determine the signal direction for each bin. The DF algorithm 40 may be used to calculate the direction from a comparison of the amplitude and phase in each bin.

The illustrated hardware logic component DF algorithm 40 then compares the signal direction for each bin with the signal source directions (sectors) of interest which are provided by the user commands 54. The logic component 40 can then exclude those bins whose direction of arrival lie outside of the sectors of interest, and then pass the rest of the bins to the controlling CPU 50.

Again, the operation of the system from the controlling CPU 50 through the output of the data from the invention 10 can be the same as described in the '858 application.

### SUMMARY

The continuing development of wideband radio frequency receivers for collecting vast amounts of signal intelligence data magnifies the complexities of back-end post-processing pipelines to analyze all the data. There is an urgent need in the U.S. and foreign military and intelligence communities to create systems that can collect signals in more intelligent ways. The challenge is the overflow of information that is output from present-day signal collection systems.

Wideband receiver technology today is advancing rapidly, allowing many more signals to be captured and collected, much faster than ever before. A fundamental change in signal intelligence processing efficiency is needed for the modem military force or intelligence organization to avoid being swamped by such a massive glut of information. The modem military force or intelligence organization needs the capability to analyze signal data in a timely manner, no matter how much data is captured and collected.

Embodiments of the present invention provide signal filtering capabilities based on compass sectors of interest, so that most signal data can be discarded quickly if it does not originate from the sectors of interest. Such a system is unique in the number and type of input parameters it uses to allow the operator to tailor its filtering results, and solves the efficiency issues of conventional systems. Such a system also greatly enhances the operational capabilities of the modern intelligence organization, by allowing the organization to filter many extraneous collected signals. Certain embodiments rely only on the addition of direction-finding methods so that short duration signals can be captured and DF'd simultaneously.

The system could first have all the abilities of the system described by the '858 application. Secondly, the system can automatically detect the direction of the incoming signals (relative to the user), to add that information to the filtering decision logic. Finally, the system may provide a user interface so that operators can set up the system to filter signals based upon their direction, thereby enhancing efficiency in the analysis processing and post-processing pipeline.

Those skilled in the art can now appreciate from the foregoing description that the broad techniques of the embodiments of the present invention can be implemented in a variety of forms. Therefore, while the embodiments have been described in connection with particular examples thereof, the true scope of the embodiments of the invention should not be so limited since other modifications will become apparent to the skilled practitioner upon a study of the drawings, specification, and following claims.

What is claimed is:

1. An intelligence system comprising:
a front end to generate digital data based on received RF signals;
a post-processing stage to process the digital data; and
a direction finding stage to prevent the post-processing stage from processing portions of the digital data that correspond to RF signals arriving from a direction other than a predetermined direction.

2. The intelligence system of claim 1, wherein the front end is to collect the RF signals in a plurality of parallel channels.

3. The intelligence system of claim 2, wherein the direction finding stage is to identify an arrival direction for each of a plurality of frequency bins by determining at least one of a phase difference and a frequency difference between data in the plurality of channels.

4. The intelligence system of claim 2, wherein each channel includes:
an antenna to collect the received RF signals;
a wideband downconverter to generate analog intermediate frequency signals based on the received RF signals;
an analog to digital converter to generate the digital data based on the RF signals; and
a fast Fourier transform module to convert the digital data into frequency domain data.

5. The intelligence system of claim 2, wherein the plurality of channels includes a north-south channel, an east-west channel and a reference channel.

6. The intelligence system of claim 1, wherein the direction finding stage is to generate bin data that identifies frequency bins associated with RF signals arriving from the predetermined direction, the system further including a controller CPU to receive the bin data.

7. The intelligence system of claim 1, further including a user input to receive an indication of the predetermined direction.

8. The intelligence system of claim 7, wherein the user input includes a compass display in which the predetermined direction is to be identified by sweeping a sector of the compass.

9. A method of collecting intelligence comprising:
generating digital data based on received RF signals; and
preventing portions of the digital data that correspond to RF signals arriving from a direction other than a predetermined direction from being processed.

10. The method of claim 9, further including collecting the RF signals in a plurality of parallel channels.

11. The method of claim 10, further including identifying an arrival direction for each of a plurality of frequency bins by determining at least one of a phase difference and a frequency difference between data in the plurality of parallel channels.

12. The method of claim 10, wherein the generating includes, for each parallel channel:
collecting the received RF signals;
generating analog intermediate frequency signals based on the received RF signals; and
generating the digital data based on the RF signals, the method further including converting the digital data into frequency domain data for each parallel channel.

13. The method of claim 1, wherein the preventing includes:
generating bin data that identifies frequency bins associated with RF signals arriving from the predetermined direction; and
receiving the bin data at a controller CPU.

14. The method of claim 1, further including receiving an indication of the predetermined direction at a user input.

15. The method of claim 14, wherein the receiving includes detecting a user sweeping of a sector of a compass display.
